(19) United States
(12) Patent Application Publication
(10) Pub. No.: US 2014/0032286 A1
(43) Pub. Date: Jan. 30, 2014

(54) Social Networking Advertising Campaign Management

(71) Applicant: Offerpop Corporation, New York, NY (US)

(72) Inventors: Wendell Lansford, New York, NY (US); Prakash Mishra, Stamford, CT (US)

(73) Assignee: Offerpop Corporation, New York, NY (US)

(21) Appl. No.: 13/950,876

(22) Filed: Jul. 25, 2013

Related U.S. Application Data
(60) Provisional application No. 61/675,432, filed on Jul. 25, 2012.

(51) Int. Cl. G06Q 50/00; G06Q 30/02

(52) U.S. Cl. CPC G06Q 50/01; G06Q 30/0263
USPC 705/14.6

(57) ABSTRACT

A computer-based system enables categories to be associated with content in an online social networking system. For example, a user of such a system may post a unit of content to such a system and associate one or more categories with that unit of content. As a result, the user-specified categories are stored in the social networking system in association with the posted content. When the posted content is displayed to users of the online social networking system, the categories associated with the posted content may or may not be displayed in association with the posted content. The set of categories associated with the posted content may be modified after the content is posted. Users other than the user who posted the content may be enabled to post other content within the same categories, but may be prevented from modifying those categories.

### CROSS-REFERENCE TO RELATED APPLICATIONS

This application claims priority from U.S. Prov. Pat. App. Ser. No. 61/675,432, filed on Jul. 25, 2012, entitled, “Social Networking Advertising Campaign Management,” which is hereby incorporated by reference herein.

This application is related to U.S. patent application Ser. No. 13/871,282, filed on Apr. 26, 2013, entitled, “Category Manager for Social Network Content,” which is hereby incorporated by reference herein.

### BACKGROUND

Online social networking systems, such as Facebook, are becoming increasingly popular vehicles for advertising products and services. One way in which a company can advertise on Facebook is to create an advertising campaign that is associated with one of the company's pages on Facebook, also known as a “wall” or “timeline.” The company may have a separate Facebook wall for each of its products and services, and a corresponding advertising campaign associated with each such wall.

Both the company that owns a particular Facebook wall and other users of Facebook, such as the company's customers or potential customers, may post content, known as “wall posts,” to that Facebook wall. If the company has purchased and associated an advertising campaign with that Facebook wall, then when a new post is posted to the wall, whether by the company or another user, or when a user engages with the wall itself or any content on the wall, such as by clicking a “like” button, Facebook may display an advertisement in connection with the event. The content of the advertisement is typically selected to be related to the product or service that is the subject of the wall. In this way, Facebook provides the company with a mechanism for providing advertisements for its products or services in connection with content that is posted to the Facebook walls associated with those products and services.

As mentioned above, each advertisement on Facebook is associated with an advertising campaign. A Facebook user (such as a company or an individual) who desires to display advertisements on one of the user's Facebook walls creates a campaign on Facebook to act as a vehicle for displaying those advertisements. The user must also provide values for a variety of parameters associated with the campaign. One of those parameters is a funding source, such as a credit card, to be charged by Facebook to the user each time Facebook displays an advertisement on the user's Facebook wall as part of the campaign.

Another such parameter is a maximum daily budget for the campaign. Once the total amount charged by Facebook to the user for advertisements displayed via the campaign in a particular day exceeds the campaign's maximum daily budget, Facebook will stop displaying advertisements via the campaign for the remainder of the day. At the beginning of the next day, Facebook will reset the total amount spent pursuant to the campaign to zero and begin displaying advertisements pursuant to the campaign. Examples of other parameters associated with a campaign are the users to target with the campaign and the amount to be spent per click on each advertisement displayed via the campaign.

In summary, Facebook advertising campaigns are associated with a particular Facebook wall. The parameters of a particular campaign, such as its funding source and maximum daily budget, therefore, are associated with the Facebook wall as a whole and with all advertisements displayed on that wall pursuant to the advertising campaign.

One of the advertising-related features provided by Facebook is known as “sponsored stories.” If a user interacts with content on a particular company's Facebook wall, such as by posting comments on that wall, or “liking” content on that wall, the sponsored story feature will post an advertisement on the Facebook wall of the Facebook friends of that user. For example, if a user named John Smith clicks on the Facebook “like” button on the Starbucks Facebook wall to indicate that he likes Starbucks, then the sponsored story feature will post an advertisement on the Facebook walls of John Smith's friends stating that “John Smith likes Starbucks.” Such sponsored story advertisements are created by Facebook only if Starbucks has created a sponsored story advertising campaign in advance, in which case Facebook will charge Starbucks a fee for each sponsored story advertisement that Facebook creates (“cost per impression” pricing), or for each such sponsored story advertisement on which a user clicks (“cost per click” pricing).

When a company creates a sponsored story advertising campaign, the company must specify which user activity to sponsor (i.e., which user activity will trigger the creation of sponsored story advertisements). For example, the company may specify that a sponsored story advertising campaign should sponsor all wall posts on one of the company's Facebook pages. As a result, whenever any wall post is created on that Facebook page by a user, Facebook will display sponsored story advertisements based on that wall post to all friends of the user.

These and other advertising-related features of Facebook and other online social networking systems can provide significant benefits to companies and their customers (and potential customers), and generate significant revenue for Facebook and other online social networking companies. What is needed, however, are improved techniques for managing advertisements in online social networking systems.

### SUMMARY

A computer-based system enables categories to be associated with content in an online social networking system. For example, a user of such a system may post a unit of content to such a system and associate one or more categories with that unit of content. As a result, the user-specified categories are stored in the social networking system in association with the posted content. When the posted content is displayed to users of the online social networking system, the categories associated with the posted content may or may not be displayed in association with the posted content. The set of categories associated with the posted content may be modified after the content is posted. Users other than the user who posted the content may be enabled to post other content within the same categories, but may be prevented from modifying those categories.

### BRIEF DESCRIPTION OF THE DRAWINGS

FIG. 1 is a dataflow diagram of a system for managing advertisements in online social networking systems according to one embodiment of the present invention.

FIG. 2 is a diagram of a data structure for storing selection data according to one embodiment of the present invention.

### DETAILED DESCRIPTION

A computer-based system enables users (whether individuals or organizations) of online social networking systems to associate advertising campaigns with individual units of content, such as individual posts on a Facebook wall. For example, the system enables the user to manually select units of content to associate with each advertising campaign. As another example, the system enables the user to associate criteria with each advertising campaign. The categories disclosed in the above-referenced patent application entitled, “Category Manager for Social Network Content,” are examples of “criteria” as that term is used herein. The criteria associated with a particular advertising campaign are applied units of content to determine whether to associate an advertisement from that advertising campaign with each unit of content. As a result, the system enables a single collection of content (such as a Facebook page) to contain units of content associated with different advertising campaigns and/or units of content not associated with any advertising campaign.

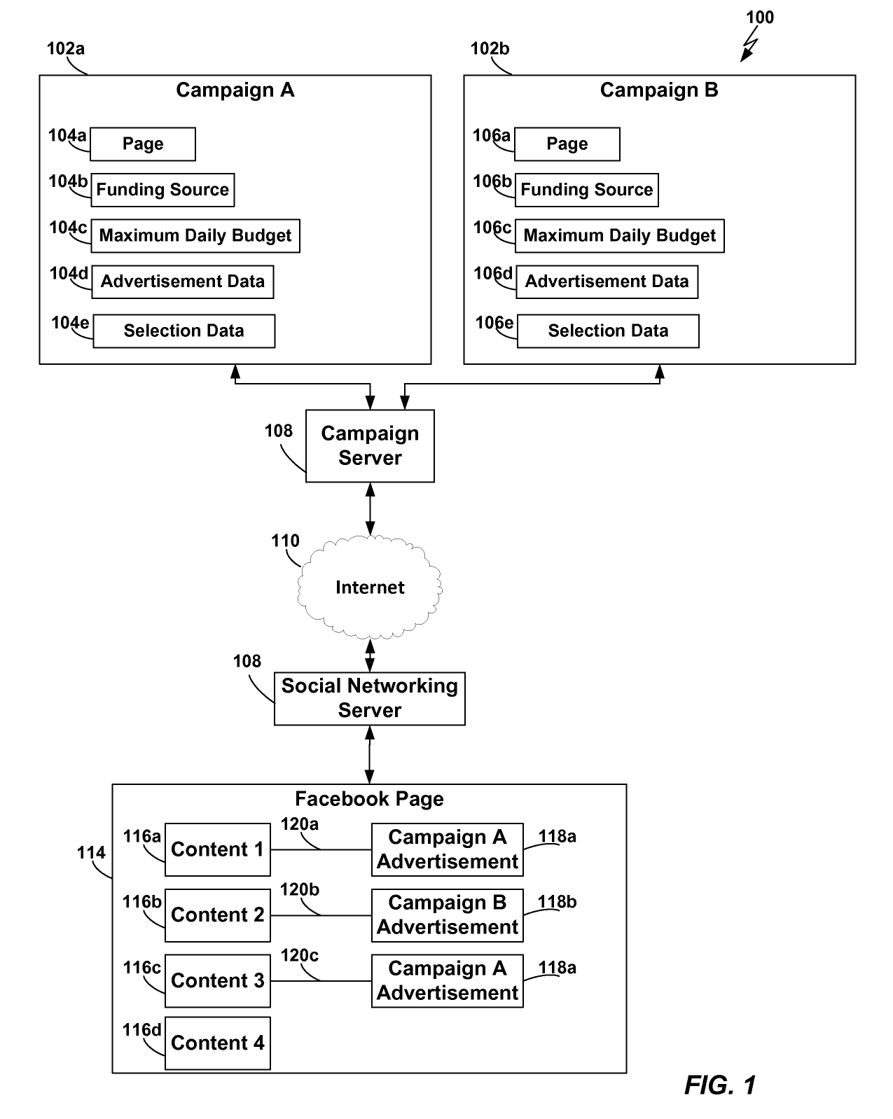

Referring to FIG. 1, a diagram is shown of a system 100 implemented according to one embodiment of the present invention. The system 100 includes a plurality of sets of advertising campaign data 102a-b. Although only two sets of advertising campaign data 102a-b are shown in FIG. 1 for ease of illustration, the system 100 may include any number of advertising campaign data sets. Furthermore, although both campaign data set 102a and campaign data set 102b may be described below as being owned by, hosted by, or otherwise associated with a single user of an online social networking system (such as a single individual user or a single entity, such as a for-profit company), the system 100 may include campaign data sets associated with any number of users of one or more online social networking systems. Each such user may be associated with any number of campaign data sets. For example, campaign data set 102a may be associated with a first company and campaign data set 102b may be associated with a second company.

Furthermore, any reference herein to a “company” should be understood to refer more generally to any entity, such as a for-profit or non-profit organization, or an individual person. Similarly, any reference herein to a “user” of an online social networking system should be understood to refer to any entity that has an account with or identifier within the online social networking system. Such an entity may, for example, be a for-profit or non-profit organization (or any department, division, or other part thereof) or an individual.

Each of campaign data sets 102a and 102b contain a variety of data representing a corresponding advertising campaign. Such an advertising campaign may be used to run advertisements within a single online social networking system or across multiple online social networking systems. Certain examples of campaign data are shown in FIG. 1. Such examples are shown merely for ease of illustration and do not constitute limitations of the present invention. The campaign data sets 102a-b need not contain all of the data shown in FIG. 1, and may contain data in addition to the data shown in FIG. 1.

For example, campaign data set 102a contains a page identifier 104a, which may be any data that identifies one or more pages on an online social networking system to which the advertising campaign represented by campaign data 102a is to be applied. As will be described in more detail below, in some embodiments, advertisements that are generated pursuant to the campaign defined by campaign data 102a may be displayed on the page(s) identified by page identifier 104a. In other embodiments, advertisements that are generated pursuant to the campaign defined by campaign data 102a may be displayed on pages other than the page(s) identified by page identifier 104a in response to interaction with content on the page(s) identified by page identifier 104a, such as the posting of content or posting comments in connection with content. The term “page” is used herein to refer generally to any collection of content in an online social networking system, such as a Facebook page or wall, Twitter tweets (e.g., a set of tweets posted by a particular Twitter account), or content within Instagram. The term “content collection” is therefore used synonymously with “page” herein. Although the page identifier 104a may identify more than one page, the description herein may refer to the single page identified by page identifier 104a solely for ease of explanation and not limitation.

The campaign data 102a also includes a funding source identifier 104b, which may be any data that identifies one or more funding sources to be used to fund the advertising campaign represented by campaign data 102a. Such a funding source may, for example, be a credit card, bank account, or payment service (e.g., PayPal) account. Although the funding source identifier 104b may identify more than one funding source, the description herein may refer to the single funding source identifier by funding source identifier 104b solely for ease of explanation and not limitation.

The campaign data 102a also includes a maximum daily budget identifier 104c, which may be any data that identifies the maximum daily budget to be applied to the advertising campaign represented by campaign data 102a. The system 100, or a separate online social networking system, may keep track of the total amount charged to the owner of the campaign represented by campaign data 102a in any particular day pursuant to that campaign, and prevent additional advertisements from being generated pursuant to that campaign in response to detecting that the total amount charged exceeds the amount specified by the maximum daily budget identifier 104c.

The campaign data 102a also includes advertisement data 104d, which may be any data that defines the content of one or more advertisements to be generated pursuant to the campaign represented by campaign data 102a. The advertisement data 104d may be static content, such as an image or static HTML code. Alternatively, for example, the advertisement data 104d may define dynamic advertising content, such as a contextual advertisement having content that varies depending on the context within which it is generated and/or displayed.

The page identifier 104a, funding source identifier 104b, maximum daily budget identifier 104c, and advertisement data 104d are examples of data that may be found in conventional advertising campaign data in online social networking systems such as Facebook. As such, the page identifier 104a, funding source identifier 104b, maximum daily budget identifier 104c, and advertisement data 104d are shown merely for purposes of example and not limitation. The campaign data 102a-b may include other data found in conventional advertising campaign data, in addition to or instead of the data shown in FIG. 1. Furthermore, conventional campaign data elements need not be contained within the campaign data 102a-b maintained by the system 100. Alternatively, for example, the system 100 may use existing data structures provided by an online social networking system to store such conventional campaign data, in which case the system 100 may link to or otherwise leverage such existing data structures without recreating their contents from scratch within the system 100.

Similarly, campaign data 102b contains page identifier 106a, funding source identifier 106b, maximum daily budget identifier 106c, and advertisement data 106d, which may contain data for performing the same functions as page identifier 104a, funding source identifier 104b, maximum daily budget identifier 104c, and advertisement data 104d, respectively. The contents of campaign data 102a may differ, however, from the contents of campaign data 102b. For example, page identifier 104a may identify a different page than page identifier 106a, funding source identifier 104a may identify a different funding source than funding source identifier 104b, maximum daily budget identifier 104c may identify a different maximum daily budget than maximum daily budget identifier 106c, and advertisement data 104d may define different advertising content than advertisement data 106d.

Some or all of the data in campaign data 102a, however, may be the same as data in campaign data 102b. For example, page identifier 104a may specify the same page as page identifier 106a. As another example, funding source identifier 104b may specify the same funding source as funding source identifier 106b. As yet another example, maximum daily budget identifier 104c may specify the same maximum daily budget as maximum daily budget identifier 106c. As a further example, advertisement data 104d may define the same advertising content as advertisement data 106d.

In addition to the conventional data 104a-d, campaign data 102a contains selection data 104e, which may be any data that may be used to select one or more units of content on the page identified by page identifier 104a. As described in more detail below, the system 100 will generate an advertisement pursuant to the campaign represented by campaign data 102a in association with a particular unit of content on the page represented by page identifier 104a only if that unit of content satisfies the criteria defined by selection data 104e. As a result, the system 100 may use campaign data 102a to selectively generate advertisements in connection with some, rather than all, of the content on the page represented by page identifier 104a.

Similarly, campaign data 102b contains selection data 106e, which may be any data that may be used to select one or more units of content on the page identified by page identifier 106a. As described in more detail below, the system 100 will generate an advertisement pursuant to the campaign represented by campaign data 102b in association with a particular unit of content on the page represented by page identifier 106a only if that unit of content satisfies the criteria defined by selection data 106e. As a result, the system 100 may use campaign data 102b to selectively generate advertisements in connection with some, rather than all, of the content on the page represented by page identifier 106a.

The system 100 also includes an advertising campaign server 108, which may read data from and write data to campaign data 102a-b in response to requests to read and write data, respectively. Campaign server 108 may send and receive data over the Internet 110 or other network. Campaign server 108 may serve advertisements on social networking pages by sending and receiving commands and data to and from a social networking server 112, such as a server that serves Facebook pages, such as Facebook page 114. Alternatively, for example, campaign server 108 may serve advertisements directly onto social networking pages (i.e., without the use of social networking server 112).

Assume for purposes of example, that the Facebook page 114 illustrated in FIG. 1 is specified by both the page identifier 104a of campaign data 102a and the page identifier 106a of campaign data 102b. In other words, the campaigns represented by campaign data 102a and 102b both apply to the same Facebook page 114 in the example of FIG. 1.

Facebook page includes content 116a, 116b, 116c, and 116d. Such content may be referred to herein as “units of content” or simply as “content.” Each unit of content may, for example, be or include any one or more of the following: a wall post, a link, a photograph, a video, a user action story reporting a Facebook “like” or other action, or a comment.

The Facebook page 114 also includes advertisement 118a, which was generated pursuant to the campaign represented by campaign data 102a and which is associated 120a with content 116a; advertisement 118b, which was generated pursuant to the campaign represented by campaign data 102b and which is associated 120b with content 116b; and advertisement 118c, which was generated pursuant to the campaign represented by campaign data 102a and which is associated 120c with content 116c. Note that content 116d is not associated with any advertisement. The particular contents 116a-d, advertisements 118a-c, and associations 120a-c in FIG. 1 are shown merely for purposes of example and do not constitute limitations of the present invention.

The presence of advertisement 118a within page 114, and the association 120a between advertisement 118a and content 116a, implies that the campaign server 108 determined that the content 116a satisfies the criteria defined by the selection data 104e of campaign data 102a and that the campaign server 108 generated the advertisement 118a in response to that determination. Similarly, the presence of advertisement 118b within page 114, and the association 120b between advertisement 118a and content 116b, implies that the campaign server 108 determined that the content 116b satisfies the criteria defined by the selection data 106e of campaign data 102b and that the campaign server 108 generated the advertisement 118c in response to that determination. Finally, the presence of advertisement 118c within page 114, and the association 120c between advertisement 118c and content 116c, implies that the campaign server 108 determined that the content 116c satisfies the criteria defined by the selection data 104e of campaign data 102a and that the campaign server 108 generated the advertisement 118c in response to that determination. Finally, the lack of any advertisement associated with content 116d implies that the campaign server 108 did not find any selection data in any of the campaign data 102a having criteria that were satisfied by the content 116d.

The campaign server 108 may generate the advertisements 118a-c in any of a variety of ways. For example, the campaign server 108 may detect that a new unit of content has been posted on the Facebook page 114, or in response to detecting engagement of a user with an existing unit of content on the Facebook page (e.g., liking, commenting on, or sharing such content). In response to such detection, the campaign server 108 may determine, for each of the sets of campaign data 102a-b, whether the campaign's maximum daily budget has already been exceeded. If a campaign's maximum daily budget has been exceeded, then the campaign server 108 does not continue processing that campaign's data.

For each of the sets of campaign data 102a-b in the system 100 whose maximum daily budget has not been exceeded, the system determines whether the content 116a is on the page specified by the campaign data and whether the content 116a satisfies the criteria defined by the campaign's selection data. If the content 116a is determined to be on the page specified by the campaign data and to satisfy the criteria defined by the campaign's selection data, then the campaign server 108 generates an advertisement based on the campaign's advertisement data, posts the advertisement on the Facebook page 114 in association with the content 116a (such as by displaying the advertisement on the same page 114 as the content 116a, and possibly by displaying the advertisement near the content 116a on the page 114), charges the account's owner for the advertisement using the campaign's specified funding source, and updates the campaign's total amount spent today (not shown) based on the amount charged to the account owner.

The campaign server 108 may repeat these operations for each of the sets of campaign data 102a-b. As a result, the campaign server 108 may generate, zero, one, or two advertisements in association with the content 116a. In the particular example shown in FIG. 1, the campaign server 108 has generated a single advertisement 118a, pursuant to campaign 102a, in association with the content 116a.

The campaign server 108 may repeat the process described above in connection with the remaining units of content 116b-d in the Facebook page 114, in response to detection that such units of content 116b-d have been posted to the Facebook page 114. In the example of FIG. 1, this has resulted in generation of advertisement 118b in association with content 116b pursuant to campaign 102b, generation of advertisement 118c in association with content 116c pursuant to campaign 102a, and no generation of any advertisement in association with content 116d.

According to the description above, the campaign server 108 may apply the campaign data 102a-b in response to detecting that a particular unit of content has been posted to a Facebook page. This is merely one example and does not constitute a limitation of the present invention. As another example, the campaign server 108 may apply the campaign data 102a-b to some or all of the content 116a-d in the Facebook page 114 in a batch, after some or all of the content 116a-d has been posted to the Facebook page 114.

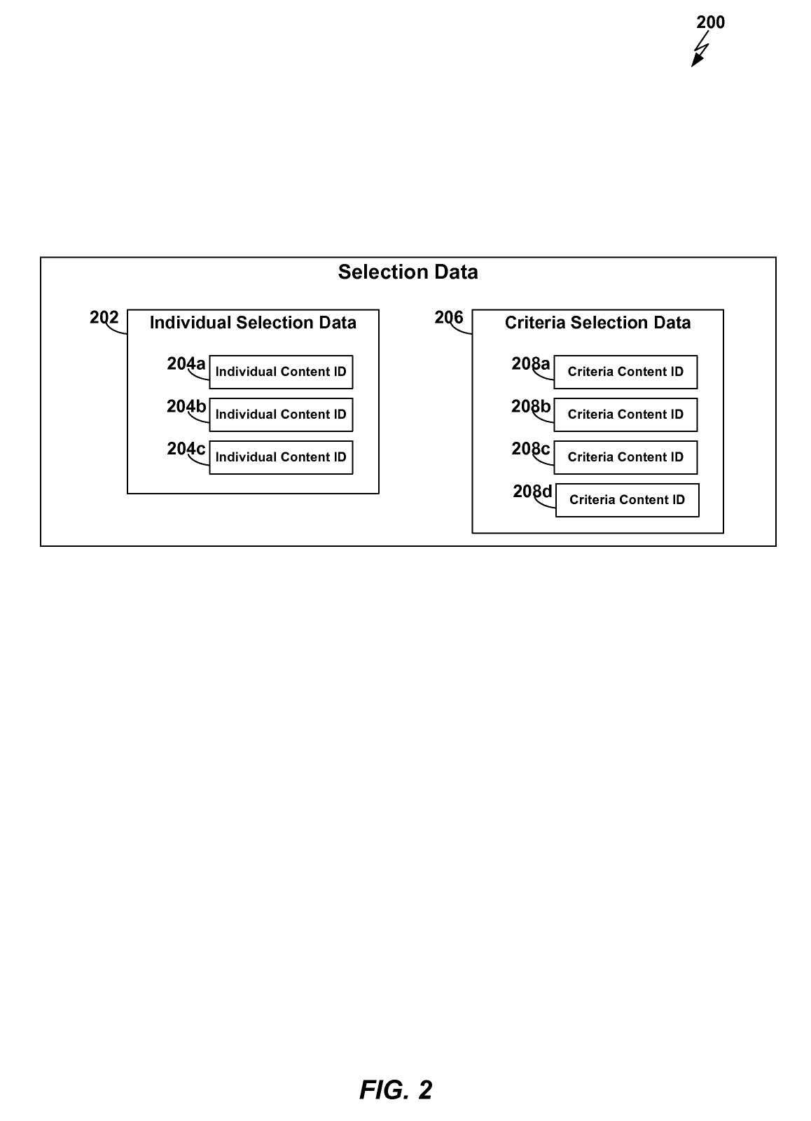

The selection data 104e and 106e was described above generally as data that defines criteria for triggering the generation of an advertisement. The selection data 104e and 106e may take any of a variety of forms. For example, referring to FIG. 2, a diagram is shown of a data structure 200 for storing selection data according to one embodiment of the present invention. A data structure having the form of data structure 200 may be used to implement the selection data 104e of campaign 102a and/or the selection data 106e of campaign 102b.

In general, the selection data 200 includes individual selection data 202 and criteria selection data 206. The individual selection data 202 specifies one or more individual units of content. More specifically, in the particular example of FIG. 2, the individual selection data 202 includes individual content identifier 204a, individual content identifier 204b, and individual content identifier 204c, each of which identifies an individual unit of content, such as an individual Facebook wall post. Although three individual content identifiers 204a-c are shown in FIG. 2, this is merely an example and does not constitute a limitation of the present invention.

The individual selection data 202 may be generated in any of a variety of ways. For example, when a user posts a unit of content, such as by posting a wall post to a Facebook wall, the user may also specify an advertising campaign to associate with that unit of content. In response, the system 100 may store, in the advertising campaign data, an individual content identifier that uniquely identifies the wall post. This enables advertisements to be generated in association with the wall post pursuant to the advertising campaign.

The criteria selection data 206 specifies one or more criteria to be applied by the campaign server 108 to units of content to determine whether they satisfy the criteria. More specifically, in the particular example of FIG. 2, the criteria selection data 206 includes criteria content identifier 208a, criteria content identifier 208b, criteria content identifier 208c, and criteria content identifier 208d, each of which defines one or more criteria. Although four criteria content identifiers 208a-d are shown in FIG. 2, this is merely an example and does not constitute a limitation of the present invention.

The criteria selection data 206 may be generated in any of a variety of ways. For example, when a user creates an advertising campaign, the user may define one or more criteria to be associated with the advertising campaign. Such criteria may be saved within the criteria selection data 206 of the advertising campaign. One example of a criterion is a text string, which is satisfied by content that contains the text string (and possibly by text that contains text similar to the text string). Another example of a criterion is a category, as described in the attached patent application entitled, “Category Manager for Social Network Content.”

Although the selection data 200 shown in FIG. 2 contains both individual selection data 202 and criteria selection data 206, this is merely an example and does not constitute a limitation of the present invention. Alternatively, for example, the selection data 200 may include only individual selection data 202 or only criteria selection data 206.

In the system 100 of FIG. 1, the campaign server 108 posts advertisements 118a-c on the same page 114 as the content 116a-c that triggered the advertisements to be generated. This is merely an example and does not constitute a limitation of the present invention. Additionally or alternatively, for example, the campaign server 108 may generate an advertisement on a page other than the page that contains the content that triggered the advertisement to be generated.

For example, in response to determining that content 116a is on the page specified by the page identifier 104a of campaign data 102a and that content 116a satisfies the criteria defined by the selection data 104e of campaign data 102a, the campaign server 108 may generate an advertisement according to the advertisement data 104d and post the advertisement on one or more pages other than page 114. For example, the campaign server 108 may identify the user who posted content 116a, and post the advertisement on the Facebook walls of some or all of the Facebook friends of the user who posted content 116a. This technique may be used to apply embodiments of the present invention to Facebook's “sponsored stories” feature.

Although certain embodiments are described herein as being applied to a single online social networking system, such as Facebook, this is merely an example and does not constitute a limitation of the present invention. Alternatively, for example, the system 100 may enable a single campaign data set, such as either or both of campaign data sets 102a and 102b, to be used in connection with a plurality of online social networking systems to perform any of the functions disclosed herein.

Embodiments of the present invention have a variety of advantages. For example, as described above, when using existing functionality provided by Facebook, an advertising campaign is associated with all posts on a particular Facebook wall. Such functionality does not allow the owner of the wall to specify that the advertising campaign should be associated with some posts on the wall and not others. In contrast, embodiments of the present invention enable the user to specify that an advertising campaign should be associated only with some posts on a wall and not others. Because users must pay a fee for each advertisement generated pursuant to an advertising campaign, embodiments of the present invention therefore enable users to exert greater control over their advertising campaign budgets and to focus those budgets on advertisements triggered only by wall posts specified by the user. Embodiments of the present invention may therefore be used to reduce advertising dollars wasted by users on advertisements associated with wall posts that users deem to be of low advertising value.

Another advantage of embodiments of the present invention is that they provide users with flexibility in selecting the units of content (e.g., wall posts) to associate with a particular advertising campaign. For example, a user may manually select one or more individual units of content to associate with a particular advertising campaign. This ability to manually select units of content may be valuable to users because it may enable them to select units of content quickly and easily in comparison to the effort required to define general criteria for selecting units of content. Another benefit of the ability to manually select units of content is that it provides users with the ability to associate advertising campaigns with individual units of content that the user deems to be of high advertising value, even if those units of content do not satisfy any easily-definable criteria.

As another example, a user may define one or more criteria and associate those criteria with an advertising campaign. For example, the user may define criteria associated with a keyword or category, in which case any units of content that are on the page associated with the advertising campaign and that satisfy the criteria (e.g., that contain the keyword or are within the category) will cause an advertisement to be generated pursuant to the advertising campaign. This ability to select units of content based on criteria may be valuable to users because it provides the ability to define one set of criteria that are then applied automatically to all units of content on the associated page, thereby eliminating the need for the user to manually and individually associate each unit of content with the advertising campaign. This way of selecting content to associate with an advertising campaign may be useful in cases in which the advertising campaign is easily defined by a set of criteria.

Embodiments of the present invention may provide users with multiple options for associating units of content with advertising campaigns. For example, embodiments of the present invention may provide the user with the option of selecting units of content to associate with an advertising campaign manually or of selecting units of content for association with an advertising campaign by defining criteria. As another example, embodiments of the present invention may enable the user both to manually select units of content to associate with an advertising campaign and to define criteria to associate with the same advertising campaign, in which case both the user's manual input and the user-defined criteria may be used to select units of content to associate with the advertising campaign. These options provide the user with significant flexibility in deciding how to determine which units of content should be associated with any particular advertising campaign.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The description herein refers to certain online social networking systems, such as Facebook and Twitter, merely for purposes of example. Embodiments of the present invention are not limited to use in conjunction with these particular online social networking systems, but instead may be used in conjunction with any one or more online social networking systems. More generally, embodiments of the present invention may be used in conjunction with any online system for hosting content, such as any web site. Therefore, any reference herein to an “online social networking system” should be understood to refer more generally to any online system for hosting content, whether or not such a system includes social networking features.

Any reference herein to a “product” should be understood to refer to a product and/or a service. Similarly, any reference herein to a “service” should be understood to refer to a product and/or a service.

Certain concepts described herein may be known by other names. For example, a “wall” on Facebook or other social networking system may also be referred to as a “timeline.” As another example, a “wall post” on Facebook or other social networking system may also be referred to as a “story.” Therefore any reference to a “wall,” “wall post,” or other concept that is also known by other names should be understood to refer to the concept generally, regardless of the name by which it is referred.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A method performed by at least one computer processor executing computer program instructions stored on at least one non-transitory computer-readable medium, the method comprising:
(A) determining whether first content on a page of an online social networking system satisfies predetermined criteria, whether the predetermined criteria comprise criteria defining presence on the page and at least one additional criterion; and
(B) posting an advertisement to the page in association with the first content only if the first content is determined to satisfy the predetermined criteria.

2. The method of claim 1, wherein the at least one additional criterion comprises a unique identifier of the first content, and wherein determining comprises determining whether the first content is associated with the unique identifier of the first content.

3. The method of claim 1, wherein the at least one additional criterion comprises at least one category.

4. A non-transitory computer-readable medium comprising computer program instructions executable by at least one computer processor to perform a method, the method comprising:
(A) determining whether first content on a page of an online social networking system satisfies predetermined criteria, whether the predetermined criteria comprise criteria defining presence on the page and at least one additional criterion; and
(B) posting an advertisement to the page in association with the first content only if the first content is determined to satisfy the predetermined criteria.

5. The non-transitory computer-readable medium of claim 4, wherein the at least one additional criterion comprises a unique identifier of the first content, and wherein determining comprises determining whether the first content is associated with the unique identifier of the first content.

6. The non-transitory computer-readable medium of claim 4, wherein the at least one additional criterion comprises at least one category.

7. A method performed by at least one computer processor executing computer program instructions stored on at least one non-transitory computer-readable medium, the method comprising:
(A) determining whether first content on a first page of an online social networking system satisfies predetermined criteria, whether the predetermined criteria comprise criteria defining presence on the first page and at least one additional criterion; and
(B) posting an advertisement to a page other than the first page in association with the first content only if the first content is determined to satisfy the predetermined criteria.

8. A non-transitory computer-readable medium comprising computer program instructions executable by at least one computer processor to perform a method, the method comprising:
(A) determining whether first content on a first page of an online social networking system satisfies predetermined criteria, whether the predetermined criteria comprise criteria defining presence on the first page and at least one additional criterion; and
(B) posting an advertisement to a page other than the first page in association with the first content only if the first content is determined to satisfy the predetermined criteria.
